(19) United States
(12) Patent Application Publication
(10) Pub. No.: US 2022/0288640 A1
(43) Pub. Date: Sep. 15, 2022

(54) SCREEN APPARATUS WITH MULTI-DISCHARGE

(71) Applicant: Portafill International Limited, Omagh (GB)

(72) Inventor: Malachy James RAFFERTY, Omagh (GB)

(73) Assignee: Portafill International Limited, Omagh (GB)

(21) Appl. No.: 17/679,756

(22) Filed: Feb. 24, 2022

Related U.S. Application Data
(60) Provisional application No. 63/161,206, filed on Mar. 15, 2021.

(51) Int. Cl. B07B 9/00; B07B 1/00; B07B 1/06; B07B 1/22

(52) U.S. Cl. CPC B07B 9/00; B07B 1/005; B07B 1/06; B07B 1/22; B07B 2201/04

(57) ABSTRACT

The present invention provides a mobile multi-deck screening apparatus for screening a mixed material into three graded streams, the apparatus comprising two or more overlapping screening decks and at least three discharge conveyors, wherein one discharge conveyor is a switchable conveyor selectively switchable between an active state such that each discharge conveyor discharges one graded stream, to an inactive state such that one discharge conveyor discharges two graded streams.

### RELATED APPLICATIONS

This application is related to and claims priority from U.S. Provisional Application No. 63/161,206 filed Mar. 15, 2021, the disclosure of which is incorporated herein by reference in its entirety.

### FIELD OF THE INVENTION

The present invention relates to a mobile multi-deck screening apparatus for separating unconsolidated feed materials that contain a mixture of particle sizes into three graded streams of particle sizes, also referred to as fraction size, which can then be provided from the apparatus as two or three final discharge streams.

### BACKGROUND

Quarries, building sites, waste processing facilities and composting facilities utilise various types of screening technologies. The chosen technology will depend on the application, feed material and the desired separation. Typically, screening machines start with a feed hopper or the like, a mechanical screen, and one or more conveyors to transfer the processed materials to a nearby location or to a secondary processing plant.

A mechanical screen separates material via liner, vibratory or rotary movement. This movement agitates and moves the feed material along a screening deck. Mechanical screens typically comprise of one or more decks. A deck is a frame or apparatus that holds the screen media. A multiple deck screen contains a series of screen decks, each containing a different media; and where one deck is placed above another. The media is the material or apparatus that defines the screen's apertures size. Screen media can be made from woven wire cloth, steel mesh, perforated steel plate, perforated synthetic mats, finger tines or rotating discs. A multi deck screen can separate feed material into two or more fractions.

A screening machine capable of producing two fraction sizes is commonly referred to as a two-way-split; these fractions are generally classified as ‘oversized’ and ‘undersized’. A screening machine capable of producing three fractions is commonly referred to as a three-way-split; these fractions are classified as ‘oversized’, ‘midsized’, and ‘undersized’.

These different splits can be provided by dedicated fixed machinery known in the art.

An integral and mobile apparatus capable of operating either as a two-way-split or as a three-way-split is advantageous in several circumstances, for example where the applications or the composition of feed material is variable, or where space is limited, or where the noise of two fixed machines is environmentally too much. This is particularly when processing waste material such as, construction and industrial waste (C&I), and Municipal solid waste (MSVV).

### SUMMARY OF THE INVENTION

The present invention details apparatus able to be configured to operate either as a two-way-split or as a three-way split.

According to one aspect of the present invention, there is provided a mobile multi-deck screening apparatus for screening a mixed material into three graded streams, the apparatus comprising two or more overlapping screening decks and at least three discharge conveyors, wherein one discharge conveyor is a switchable conveyor selectively switchable between an active state such that each discharge conveyor discharges one graded stream, to an inactive state such that one discharge conveyor discharges two graded streams.

According to another aspect of the present invention, there is provided a method of switching the discharge of a mixed material graded into three graded streams, comprising at least the steps of:

providing a mobile multi-deck screening apparatus for screening the mixed material into three graded streams, the apparatus comprising two or more overlapping screening decks and at least three discharge conveyors,

selectively switching one discharge conveyor between an active state such that each discharge conveyor can discharge one graded stream, to an inactive state such that one discharge conveyor can discharge two graded streams.

Advantageously, the present invention comprises; a discharge conveyor for collecting and discharging the oversized fraction, referred to as the oversize conveyor; a discharge conveyor for collecting and discharging the midsized fraction, referred to as the midsize conveyor; an internal conveyor for collecting the undersized fraction, referred to as the collection conveyor; and a discharge conveyor for discharging the undersized fractions, referred to as the undersize conveyor.

In one embodiment, the present invention describes how an oversize conveyor can be switched to divert the flow of oversized material to a midsize conveyor, allowing the midsize conveyor to function as a ‘two in one’ discharge conveyor. In this way, the midsize conveyor can be repurposed and used to collect and transfer the oversized and midsized material together as one fraction, thus making the oversize conveyor unrequired. With this configuration, the invention can produce oversized and undersized fractions only.

The invention also describes how an oversize conveyor can moved back into position to re-collect and transfer the oversized material, therefore allowing the screening machine to revert to providing oversized, midsized, and undersized fractions.

### BRIEF DESCRIPTION OF THE DRAWINGS

The invention will be more clearly understood by the following descriptions of some embodiments thereof, given by way of example only, which reference to accompanying drawings, in which:

FIG. 1 is a perspective view of apparatus according to one embodiment of the present invention.

FIG. 2 is a side sectional view of FIG. 1.

FIG. 3 is a working illustration of a three-way split showing material.

FIG. 4 is a working illustration of a two-way split showing material.

FIG. 5 is an illustration showing movement of a discharge conveyor in a diagonal direction.

FIG. 6 is an illustration showing movement of a discharge conveyor in a vertical direction.

FIG. 7 is an illustration showing movement of a discharge conveyor in a horizontal direction.

### DETAIL DESCRIPTION OF PREFERRED EMBODIMENTS

The present invention provides a mobile multi-deck screening apparatus for screening a mixed material into three graded streams, the apparatus comprising two or more overlapping screening decks and at least three discharge conveyors, wherein one discharge conveyor is a switchable conveyor selectively switchable between an active state such that each discharge conveyor discharges one graded stream, to an inactive state such that one discharge conveyor discharges two graded streams.

Optionally, the apparatus has a main chassis to support the two or more overlapping screening decks and the at least three discharge conveyors, and a tracked mobile chassis. The apparatus may further comprise one or more sub-frames, and provides an integral apparatus in operation. The apparatus may be mobile using wheels, tracks, and other such means, or combinations of same.

Optionally, the apparatus further comprises one or more internal conveyors to convey a graded stream to a discharge conveyor. The internal conveyors may be suited to collect a particular graded stream, such as the finest-graded stream, thereby acting as a collection station for such stream, which can then be conveyed to one end of the relevant discharge conveyor for discharge beyond the apparatus for further processing or stockpiling or the like.

In one embodiment of the present invention, the apparatus comprises;

a first discharge conveyor for collecting and discharging a relative oversized fraction of the mixed material,

a second discharge conveyor for collecting and discharging a relative midsized fraction of the mixed material,

a first internal conveyor for collecting a relative undersized fraction of the mixed material, and

a third discharge conveyor for discharging the undersized fraction collected by the internal conveyor.

In one embodiment of the present invention, the switchable discharge conveyor is a first discharge conveyor for collecting and discharging a relative oversized fraction of the mixed material.

The terms oversized, midsized, and undersized are used herein in a relative sense to each other, and in a manner known in the art.

Optionally, the apparatus further comprises a stream-collecting station for one or more of the discharge conveyors, optionally all of the discharge conveyors. Each discharge conveyor may have the same or a different form, type, design or shape of stream-colleting station. A stream-collecting station may comprise any suitable form of collection chute, vessel, tray, bay, hopper or conveyor, able to collect the relevant graded stream discharged at the end of a screen, and to guide or transfer such material to one end of a discharge conveyor.

A stream-collecting station may only be the feed end of a discharge conveyor, or take the form of one or more walls, plates or baffles, designed at or near or around the feed end of a discharge conveyor.

In one embodiment of the present invention, there is a stream-collection station at or near the feed end of the switchable discharge conveyor, optionally formed as a tray.

Optionally, a stream-collection station is for collecting a relative oversized fraction of the mixed material.

Optionally, a stream-collecting station for the switchable discharge conveyor is located in its active state above another discharge conveyor.

Optionally, the stream-collecting station for the switchable discharge conveyor is not located in its inactive state above another discharge conveyor. Thus, the relevant graded stream provided at one end of a screen, and previously collected and transferred to the switchable discharge conveyor, is now provided to a feed end of another discharge conveyor. Most conveniently, this can be carried out with the aid of gravity, i.e. allowing such the discharged graded stream to fall by gravity directly towards the feed end of another discharge conveyor. This re-combines two graded streams from the apparatus, for subsequent discharge by one discharge conveyor.

Optionally, the stream-collecting station for the switchable discharge conveyor and the switchable discharge conveyor are moveable together between an active stream-collecting position to an inactive non-collecting position. For example, the stream collection station and switchable discharge conveyor may be secured together, or secured to a single frame or sub-frame to form an integral unit.

Optionally, the stream-collecting station for the switchable discharge conveyor and the switchable discharge conveyor are moveable relative to a ground surface in a direction relative to the apparatus comprising one or more of the group comprising: horizontal, vertical, lateral, or a combination of same. For example, the stream collecting station and switchable discharge conveyor could be moveable vertically relative to the remainder of the apparatus, such that the stream collecting station is no longer located at the same height relative to the discharge end of a screen, and is therefore no longer able to collect such discharge stream. Additionally or alternatively, the stream collecting station and switchable discharge conveyor could be translated horizontally away from a screen, to achieve the same non-collecting effect. In a further possible embodiment, the stream collecting station and switchable discharge conveyor are moveable diagonally away from the apparatus.

All such movement of the stream collecting station and switchable discharge conveyor could be based on a frame or sub-frame, which frame or sub-frame is moveable relative to the apparatus by one or more actuators, motors or other drives known in the art.

In an alternative or additional embodiment, the stream-collecting station for the switchable discharge conveyor is selectively switchable between discharging to the switchable discharge conveyor, and discharging to another discharge conveyor. For example, the stream collecting station for the switchable discharge conveyor may have one or more chutes, baffles, floors, walls or sides, able to collapse or move, thus changing the direction of the collection of the graded stream from the end of the relevant screen in a different direction than towards the feed end of the switchable discharge conveyor. The stream collecting station thus switches the direction of the graded stream to another discharge conveyor, typically including a vertical translation using gravity, for such graded stream to be re-combined with another graded stream, before co-discharge by another discharge conveyor.

Optionally, the switchable discharge conveyor is supported on a frame moveable relative to a frame supporting the two or more overlapping screening decks

Optionally, the switchable discharge conveyor is supported on a frame moveable relative to a frame supporting another discharge conveyor.

Optionally, each screen in the apparatus has a feed end and a discharge end. The two or more overlapping screening decks have the same or different material flow directions from an infeed hopper end to each relevant screen-discharge end. For example, a collection conveyor for the smallest discharge stream, such as the ‘undersize’ fraction, could be used to convey material back towards an infeed end. An undersized discharge conveyor could be positioned at the back of the screening apparatus, or underneath the feeder to the screening apparatus.

Optionally, the two or more overlapping screening decks have the same material flow direction from an infeed hopper end to the same or similar screen-discharge ends, and one end of each of the three graded discharge conveyors is located at or near such screening-discharge end or ends.

Each screen of the multi-deck may be the same or different, to achieve a vertical partial, substantial or full overlapping arrangement. Each screen can be either vibrating, oscillating or rotating, (i.e. having a rotating drum or rotating disks). Each deck can be made of any of these type of screens. A two-deck arrangement generally has a ‘top’ deck and a ‘bottom’ screen. Non-limiting examples include: (1) a top deck vibrating screen and a bottom deck star screen; (2) a top deck disc screen and a bottom deck vibrating screen; (3) a top deck vibrating screen and a bottom deck rotating drum screen; (4) a top deck disc screen and a bottom deck rotating drum screen; and. (5) a top deck disc screen and a bottom deck disc screen.

The skilled reader understands that other variants are possible to achieve a mobile multi-deck screening apparatus comprising two or more overlapping screening decks.

In one embodiment of the present invention, the two or more overlapping screening decks comprise a rotary drum screen and a disc screen. Optionally, the disc screen is wholly, substantially or partly located within the rotary drum screen.

The term ‘disc screen’ is used herein to include screens comprising a series of spaced rotating drums or rollers or shafts, arranged in a generally linear direction, with defined openings thereinbetween to provide the screening.

A disc screen may be arranged to angle or incline (relative to a ground surface), or to have one or more differently angled or inclined portions.

One disc screen comprises a series of shafts, optionally with a rough or roughened surface, with defined openings or spacings thereinbetween. Various other disc or star screens are known in the art, typically having a series of shafts on which rotating star or disc type wheels or other shapes are mounted. The spacing between the shafts and the wheels determines the respective openings in the screen. Separation is achieved by rotating the shafts simultaneously in the same direction to agitate and move material across the top of the shafts, discs or wheels, and so along the screen's surface. Those items, parts or particles of the material that are smaller than the openings fall through the openings, while those parts, etc. greater than the apertures continue to move along the screening surface until it exits the screen.

Disc screens are particularly suited for screening damp and bulk materials, and are particularly useful for screening biomass as they provide good agitation, which is necessary for separating the particles that tend to knit together.

Optionally, a disc screen comprises a series of discs mounted on driven shafts. The disc could have a shape selected from the group comprising: a polygon, circular, egg, ovoid or a star shape. Optionally, the disc screen comprises two or more disc screens in series, extending at least partially along the length of the rotary drum screen.

Optionally, a disc screen is mounted on a disc frame, and the disc frame securable to another screen.

Rotary drum screens are known in the art, and generally comprise a rotating mechanical screen able to separate a variety of materials into different particle sizes. The screen has a perforated cylindrical drum with various aperture sizes, rotated on or by a frame, and with a feed or input end, and a discharge or output end. Separation is achieved by rotating the drum to agitate and move the material along the drum's screening surface. Typically a rotary drum screen comprises a cylindrical drum, rotated on or by a frame, optionally at least partly in an outer housing. A disc frame may be secured to each end of the frame or housing, and extend through the drum.

Optionally, a disc frame includes a disc drive mechanism to drive the shafts and discs. The mechanism is typically a series of drive chains and cogs, able to transfer power from a motor or the like on the apparatus to the relevant shafts to drive all the discs. Such mechanisms are known in the art, and can be protected by the disc frame in use.

Where a disc screen is wholly, substantially or partly located within a rotary drum screen, the disc screen may extend beyond one or both ends of the rotary drum screen, or start within one or both ends of the rotary drum screen, or a combination of same.

Optionally, a disc screen has a feed end located within the feed end of a rotary drum screen. Optionally, the disc screen has a discharge end beyond the discharge end of a rotary drum screen.

Optionally, the frame provides side walls to the disc screen, to retain material on the disc screen that is not sized to pass through its apertures until reaching the discharge end of the disc screen.

A disc screen may have any suitable configuration relative to the rotary drum screen. Where a rotary drum screen has a longitudinal centre line along its drum length, a disc screen may wholly or substantially be positioned in line with such longitudinal centre line, optionally above or below the longitudinal centre line, and optionally being wholly, substantially or partly inclined relative to the longitudinal centre line.

Those items, parts or particles of the mixed material that are smaller than the openings in a first screen, fall through the openings, while those parts, etc. of the mixed material greater than the apertures continue to move along the screening surface until it exits the screen, and provide a first graded stream, which can be termed the ‘oversized stream’.

The material that passes through the openings in the first screen falls by gravity into a second screen below or surrounding the first screen.

Those items or parts or particles of the mixed material smaller than the apertures of the second screen pass through the screen to provide a second graded stream, which can be termed an ‘undersized stream’. Those particles, etc. of the mixed material bigger than the apertures in the second stream (but smaller than the apertures in the first screen), which can be termed a ‘midsized stream’, continue to move along the second screening surface until they exit the screen at the discharge end as a third graded stream.

Depending on the desired separation, the apertures in the second screen can vary in sizes and shape. Apparatus containing drum screens, commonly referred to as ‘trommels’, are known in the art in the pre-treatment of mixed commercial and municipal wastes; as well as for screening materials such as soil, biomass, ores, rock, sand, and aggregates.

Preferably, the multi-deck screening part of the present invention can be provided as an integrated rotary or trommel screen or unit, and a disc screen unit or assembly.

The present invention also provides a method of switching the discharge of a mixed material graded into three graded streams, comprising at least the steps of:

providing a mobile multi-deck screening apparatus for screening the mixed material into three graded streams, the apparatus comprising two or more overlapping screening decks and three discharge conveyors,

selectively switching one discharge conveyor between an active state such that each discharge conveyor can discharge one graded stream, to an inactive state such that one discharge conveyor can discharge two graded streams.

The invention can also be described as having an infeed and a discharge; with the infeed describing the input of material to be processed; with the infeed describing the screen end adjacent to the feeder; with the discharge describing the material exiting the screen for collection and transfer away from the apparatus by the discharge conveyors.

The mixed material to be screened by the present invention may comprise any mixture, including materials from quarries, building sites, waste processing facilities and composting facilities, including but not limited to feed materials that contain high volumes of damp, bulky and/or non-uniform constituents such as biomass, plastic, textiles, newspaper, and cardboard. This includes waste materials such as, construction and industrial waste (C&I), constructions and demolition waste (C&D), biomass, and Municipal solid waste (MSVV).

Optionally, the apparatus is for screening a mixed material into more three graded streams, by additional processing or screening or separation, prior to conveyance away from the apparatus.

Optionally, the apparatus further comprises a feed hopper for the mixed material, further optionally an integral feeder hopper, next to or otherwise near the feed end of one screen of the multi-decks.

The term ‘discharge’ is used herein to describe the material provided by the apparatus as a graded stream, typically for subsequent collection and stockpiling for further use or processing.

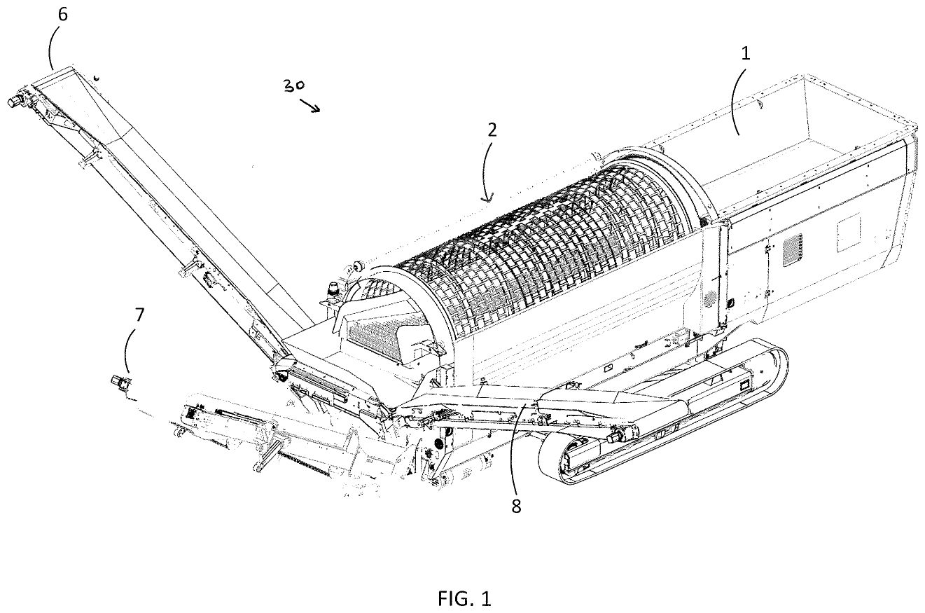

Referring to the drawings, FIG. 1 is a perspective view of an example of a mobile multi-deck screening apparatus 30 for screening a mixed material into three graded streams, the apparatus comprising two or more overlapping screening decks 2 and at least three discharge conveyors, 6, 7, 8, wherein one discharge conveyor is a switchable conveyor 8 selectively switchable between an active state to an inactive state.

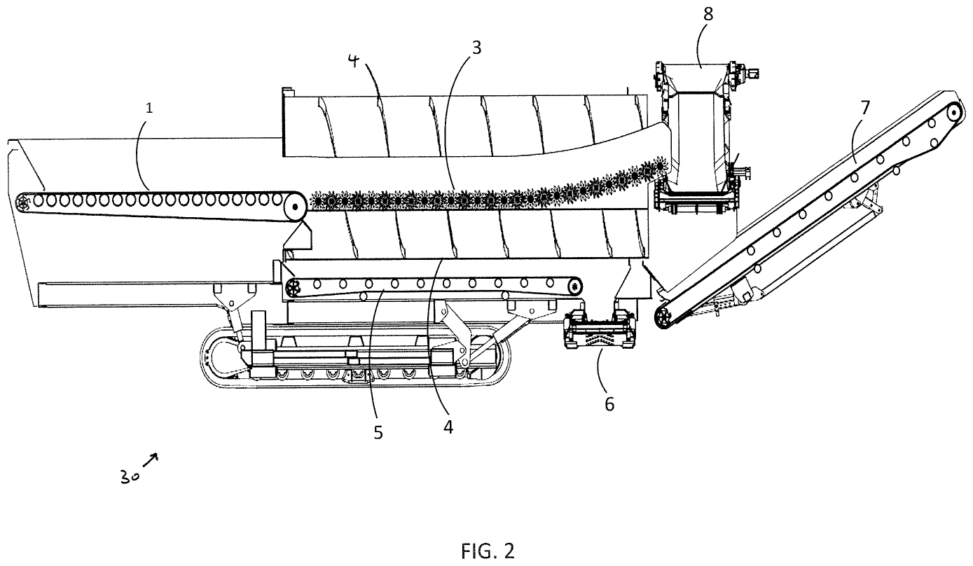

FIG. 2 is a sectional view of the apparatus 30 of FIG. 1. The apparatus 30 comprises of a feeder 1; overlapping screening decks 2 comprising two decks, an upper deck 3 being a disc screen, and lower deck 4 formed by a trommel or drum that extends wholly or substantially around the upper deck 3, and which rotates in a manner known in the art; a collection conveyor 16, positioned directly underneath the bottom of the lower deck 4; an undersize discharge conveyor 6; a midsize discharge conveyor 7 (or two-in-one discharge conveyor 17 as discussed hereinafter); and an oversize conveyor 8 as a switchable discharge conveyor.

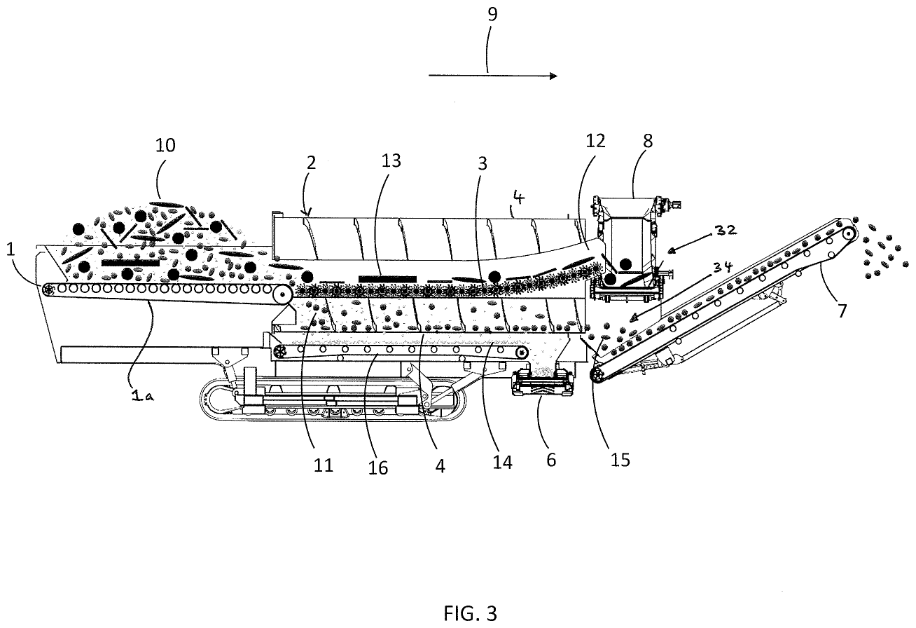

FIG. 3 illustrates a material flow direction 9 in a three-way-split configuration. In this illustration, feed material 10 enters the overlapping screening decks 2 to an upper deck 3 via the feeder 1, typically having a feed conveyor 1a. As the feed material 10 flows along the upper screen deck 3, midsized and undersized particles 11 pass through the screen's apertures and onto the deck below 4. The oversized particles 13 exit the upper screen deck 3 at a discharge end 12 towards a first collection station 32, optionally being a tray or bay or even a hopper, from which the oversize conveyor 8 collects and discharges the oversized particles 13 for further processing or stockpiling.

Meanwhile, the lower screening deck 4 separates the undersized particles 14 from the midsized particles 15; here, the undersized particles 14 pass through the lower screen deck 4 apertures and onto the internal collection conveyor 16 below as a second collection station. The collection conveyor 16 transfers the undersized particles 14 to the undersize conveyor 6, for subsequent discharge.

Meanwhile, the midsize particles 15 exit the screens 2 at a discharge end to a third collection station 34, where the midsize conveyor 7 collects and discharges the midsized particles 15.

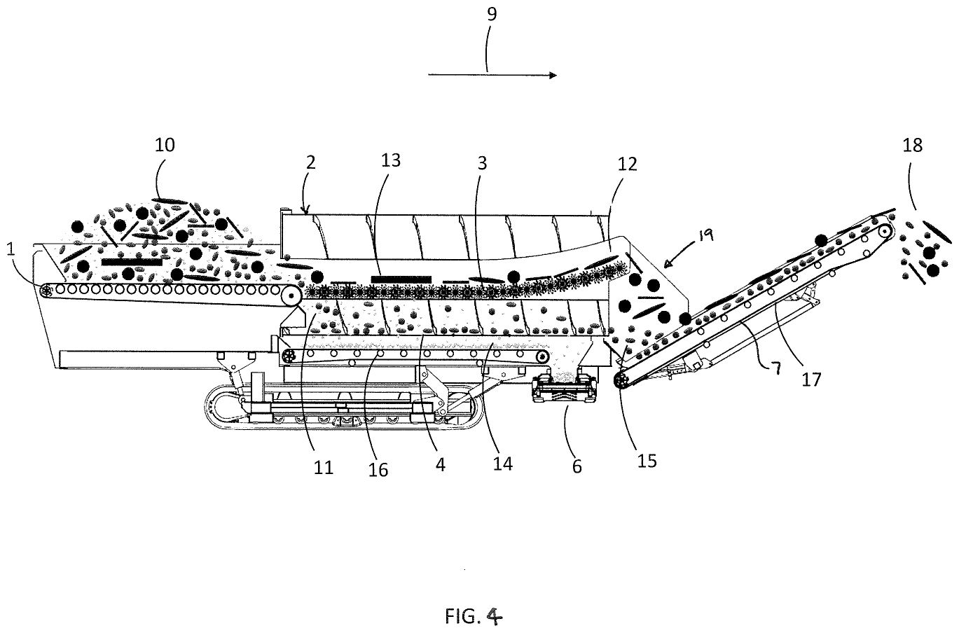

FIG. 4 illustrates the material flow 9 in a two-way-split configuration, i.e without the involvement or use of the oversize conveyor 8. In FIG. 4, the feed material 10 enters the screen decks 2 via the feeder 1 in the same way as FIG. 3. As the feed material 10 flows along the upper screen deck 3, midsized and undersized particles 11 pass through the screen's apertures and onto the screening deck below 4. The lower screening deck 4 separates the undersize 14 particles from the midsized particles 15; here, the undersize particles 14 pass through the lower screen deck 4 apertures and onto the collection conveyor 16 below. The collection conveyor 16 transfers the undersized particles 14 to the undersize discharge conveyor 6, which is subsequently discharged. The midsized particles 15 exit the screen at the discharge end.

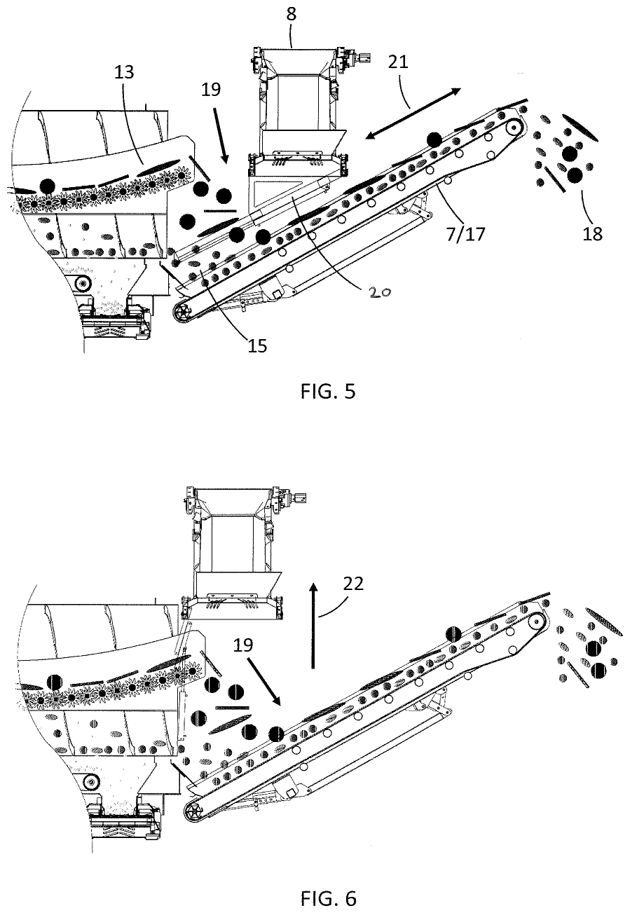

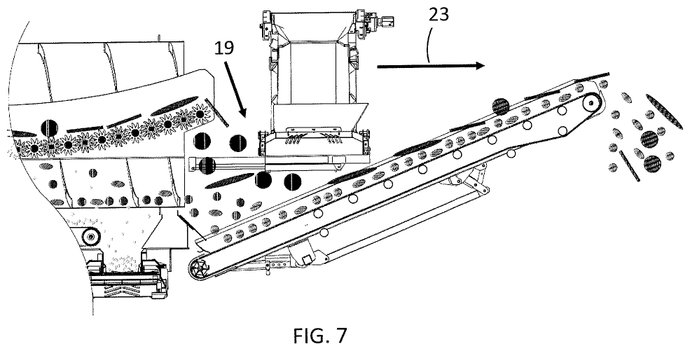

The oversize particles 13 exit the upper screen 3 at the same discharge end 12. But the apparatus 30 diverts the flow 19 of oversized particles 13 towards the stream-collection station 34 of the midsize conveyor 7 for re-combining with the midsized particles 15. This can be achieved by repositioning the oversized conveyor 8 (not shown in FIG. 4), as illustrated in FIGS. 5-7, allowing the apparatus 30 to change between a two or three-way split configuration, as illustrated in FIGS. 3 and 4. The oversized conveyor 8 is thus a switchable discharge conveyor 8.

Meanwhile, the midsize conveyor 7 becomes a two-in-one discharge conveyor 17 able to collect and discharge both the oversized 13 and midsized 15 particles as one single fraction 18.

FIGS. 5, 6 and 7 illustrate three different types of movement that will allow the oversize conveyor 8 and stream-collection station 32 to be repositioned away from the stream of oversize particles 19. FIG. 5 illustrates the movement in a diagonal direction 21. FIG. 6 illustrates the movement in a vertical direction 22. FIG. 8 illustrates the movement in a horizontal 23 direction.

Thus, when the apparatus 30 is operating in a three-way-split configuration, the oversize conveyor 8 and stream-collection station 32 are positioned directly next to the discharge end 12 of the upper screen 3, allowing the oversize conveyor 8 to collect and discharge the oversize particles 13 as a separate fraction, as illustrated in FIG. 3.

And when the apparatus 30 is operating in a two-way-split configuration, the oversize conveyor 8 and stream-collection station 32 are positioned away from the discharge end 12 of the upper screen 3, and away from the flow of material 19, as illustrated in FIGS. 5, 6 and 7. As a result, the oversized particles 13 divert towards 19 the midsize conveyor 7, effectively making the oversize conveyor 8 inactive. The midsize conveyor 7 is thus repurposed, as in, the purpose of the midsize conveyor 7 is now to collect and discharges the oversize 13 and midsize 15 particles together as one distinct fraction 18. Thus, the midsize conveyor 7 is re-designated, and is referred to as the two-in-one conveyor 17.

The present invention provides an integral and mobile apparatus capable of operating either as a two-way-split or as a three-way-split for three different grade streams of a mixed feed material.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalent.

1. A mobile multi-deck screening apparatus for screening a mixed material into three graded streams, the apparatus comprising two or more overlapping screening decks and at least three discharge conveyors, wherein one discharge conveyor is a switchable conveyor selectively switchable between an active state such that each discharge conveyor discharges one graded stream, to an inactive state such that one discharge conveyor discharges two graded streams.

2. Apparatus as claimed in claim 1, having a main chassis to support the two or more overlapping screening decks and the at least three discharge conveyors, and a tracked mobile chassis.

3. Apparatus as claimed in claim 1, further comprising one or more internal conveyors to convey a graded stream to a discharge conveyor.

4. Apparatus as claimed in claim 1, further comprising:
a first discharge conveyor for collecting and discharging a relative oversized fraction of the mixed material,
a second discharge conveyor for collecting and discharging a relative midsized fraction of the mixed material,
a first internal conveyor for collecting a relative undersized fraction of the mixed material, and
a third discharge conveyor for discharging the undersized fraction collected by the internal conveyor.

5. Apparatus as claimed in claim 1, comprising a stream-collecting station for the switchable discharge conveyor, located in its active state above another discharge conveyor.

6. Apparatus as claimed in claim 5, wherein the stream-collecting station is not located in its inactive state another discharge conveyor.

7. Apparatus as claimed in claim 5, wherein the stream-collecting station and the switchable discharge conveyor are moveable together between an active stream-collecting position to an inactive non-collecting position.

8. Apparatus as claimed in claim 7, wherein the stream-collecting station and the switchable discharge conveyor are moveable relative to a ground surface in a direction relative to the apparatus comprising one or more of the group comprising: horizontal, vertical, lateral, or a combination of same.

9. Apparatus as claimed in claim 5, wherein the stream-collecting station for the switchable discharge conveyor is selectively switchable between discharging to the switchable discharge conveyor, and discharging to another discharge conveyor.

10. Apparatus as claimed in claim 1, wherein, the switchable discharge conveyor is supported on a frame moveable relative to a frame supporting the two or more overlapping screening decks

11. Apparatus as claimed in claim 1, wherein the switchable discharge conveyor is supported on a frame moveable relative to a frame supporting another discharge conveyor.

12. Apparatus as claimed in claim 1, wherein the two or more overlapping screening decks have the same material flow direction from an infeed hopper end to a screening-discharge end, and wherein one end of each of the three graded discharge conveyors is located at or near the screening-discharge end.

13. Apparatus as claimed in claim 1, wherein the two or more overlapping screening decks comprise a rotary drum screen and a disc screen.

14. Apparatus as claimed in claim 13, wherein the disc screen is wholly, substantially or partly located within the rotary drum screen.

15. A method of switching the discharge of a mixed material graded into three graded streams, comprising at least the steps of:
providing a mobile multi-deck screening apparatus for screening the mixed material into three graded streams, the apparatus comprising two or more overlapping screening decks and three discharge conveyors,
selectively switching one discharge conveyor between an active state such that each discharge conveyor can discharge one graded stream, to an inactive state such that one discharge conveyor can discharge two graded streams.
